(19) United States
(12) Patent Application Publication
(10) Pub. No.: US 2005/0188213 A1
(43) Pub. Date: Aug. 25, 2005

(54) System for personal identity verification

(76) Inventor: Xiaoshu Xu, Santa Clarita, CA (US)

Correspondence Address: Michael A. Ervin, 8202 Talbot Cove, Austin, TX, 78746, US

(21) Appl. No.: 10/784,556

(22) Filed: Feb. 23, 2004

(51) Int. Cl. G06K 9/00

(52) U.S. Cl. 713/186

(57) ABSTRACT

A biometric based system with advanced security and privacy characteristics for the verification of a person's identity using embedded neural net structures and associated weights that process input and output data in parallel and require no central processing unit or microcontroller; resulting in low power dissipation, low cost processing chip, and affordable verification solution for portable uses such as financial transaction cards, identification cards, computers, wireless devices, keyless wireless entry systems, and others.

### TECHNICAL FIELD

The invention relates generally to implementations of verifications of biometric information on individuals that can be applied to a variety of devices such as financial transaction cards, ID cards, computers, cellular phones, keyless wireless entry systems, and the like.

### BACKGROUND

Biometric security has grown in importance and includes many technical approaches. Biometrics refers to authentication techniques that rely on measurable physiological and individual characteristics that can be verified. Biometric systems will play a critical role in the future of security and privacy. Biometric technology is usually based on one or more of the following unique identifiers: 1) fingerprint, 2) voice, 3) face, 4) handprint, 5) iris, 6) retina, 7) signature, 8) DNA, or 9) brainwave. Depending on the context a biometric system can be either a verification (authentication) or an identification system. Verification (am I who I claim to be?) involves confirming or denying a person's claimed identity. Identification (who am I?) is focused on establishing a person's identity. Biometrics can be used to prevent unauthorized access to ATMs, cellular phones, smart cards, desktop PCs, workstations, and computer networks. It can be used during transactions conducted by telephone or Internet, including electronic commerce and electronic banking. Biometrics is playing a crucial role in military security. Biometrics can also replace keys with keyless wireless entry devices for motor vehicles or buildings.

Fingerprint authentication devices have been in use for a number of years. Typically, fingerprint authentication devices use a fingerprint sensor that detects ridges, gaps, and contours within the interstices in the fine lines of a human fingerprint. Generally, this data is conditioned by a computational processing unit that removes random data signals (noise) caused by variations in detection devices and the substrates and filaments that come in contact with a finger. Then a computational process analyzes the resulting data to extract a series of discrete “biometric” features found to be common to most fingerprint data by one researcher or another and found in the data resulting after noise removal. The combination of these discrete biometric features with their attendant qualities and quantities can describe a specific fingerprint. Further, a database may store a series of such biometric readings for multiple individuals. Thus, an individual claiming to be a certain person can place a finger on a fingerprint sensor and a computer can match the biometric data calculated from the person's fingerprint with the biometric data from the claimed identity in the database. A variant of this approach would involve an unknown person who makes no claim to a specific identity. The biometric data from such a person could be compared to a general database of such data for all persons to find a match or a matching group of identities with the same biometric data.

A long felt need in the marketplace has been to make biometric authentication technology portable enough to use in applications such as ISO-compliant financial cards, ID cards, or keyless wireless entry devices, all of which tend to be small and/or very thin. The main problems with conventional fingerprint as well as other biometric authentication devices in these type of applications is that the systems are simply too complex in terms of cost, size, energy requirements, and computational power to fit into such a small working space. Relative to such devices the biometric sensors and their accompanying verification algorithms tend to require too much computational complexity, be too large, require too much battery power, and are too expensive. Further, to detect an adequate depth and quantity of characteristics from a fingerprint for reduction to a set of biometrics, the resolution must be relatively dense, requiring high-resolution fingerprint sensors. Both the foregoing are expensive solutions, since costly fingerprint sensors must exist at each place a person's biometric data is to be authenticated, and the act of authentication requires a relatively powerful processing capability to calculate the biometric data. This is essentially a relatively non-portable solution, as the authentication can occur only where there exists adequate processing capabilities and access to an existing and reliable dataset against which to challenge the candidate fingerprint biometrics.

The other serious issue regarding the use of biometric technology is the privacy issue. The extent to which biometrics threaten (or enhance) privacy depends on the use to which they are put. Some uses appear to have the potential for greater privacy threats or enhancements to privacy than others. The actual level of the threat or enhancement will vary according on the particular context. Use of biometrics for authentication may have a low level of privacy risk provided that the authentication system involves the individual knowingly exercising a choice to enroll in a system and the system does not require the authenticating body to hold large amounts of information about an individual except that necessary to establish that the person is who they claim to be. The effectiveness and efficiency of current biometric uses depends on computer technology and electronic devices. This means that most of the privacy risks associated with computer technology also apply to biometric systems. Systems that involve storage of data on, and processing and transmission using, computer technology are subject to hacking and unauthorized access, use and disclosure.

Biometrics has the potential to work as a privacy enhancing technology (PET) or a privacy intrusive technology (PIT). The impact of the technology depends on, but is not limited to, how it is designed, deployed, collected, stored, managed, and used. Critical factors are whether privacy is built in from early design stages and the extent of choice, openness and accountability. The interaction of privacy and biometrics and potential impacts on privacy through the collection and use of biometric information may include or depend on: the extent of personal information collected and stored in the context of a biometric application; the extent of choice for people about whether to provide biometric information; the fact that biometrics are a powerful identification tool but also can go powerfully wrong; and potential for greater and possibly covert collection of very sensitive information in the course of ordinary transactions. Potential impacts of biometrics and privacy and how they may apply to biometric applications both in the public and private sectors raises considerations such as: bodily privacy in the collection of biometrics; openness and choice in the collection of biometrics; anonymity; potential for data linkage and function creep; and potential for biometric information to act as a universal unique identifier.

All of these considerations have a relevant bearing on how to think about biometrics. Another perspective is that at the same time as the use of biometrics may pose a threat to privacy; there are many possible benefits to individuals, including the possibility of better protection from identity theft and the convenience of not having to remember multiple PINs or passwords. The present invention addresses the earlier mentioned technical challenges while actually enhancing privacy.

As further background U.S. Pat. No. 4,582,985 to Löfberg describes a data carrier of the credit card type for a user that includes a fingerprint sensor on the card, a means of reading information from that sensor, a signal processor that forms a biometric identification bit sequence from that reading, a memory for storing a previously obtained reference bit sequence from that user during an enrollment process, a comparator means for comparing the identification bit sequence with the reference bit sequence and for generating an acceptance signal when the degree of coincidence between the bit sequences is within a pre-determined acceptance range. The algorithm for generating the cards identification bit sequence is the same as the enrollment process algorithm. Because of that algorithm the card requires a significant on-board microprocessor. The generation of the identification bit sequence on the card is a computationally intense sequence requiring a scanning sequence of the fingerprint image driven by the microprocessor, which is programmed to do serial, procedural processor instructions. Perhaps because of the cost and energy usage of the high computational requirement this type of application has not proved to be commercially successful to date.

U.S. Pat. No. 5,623,552 to Lane discloses a different approach involving moving the enrollment process onto the card. It teaches a card with a built in sensor that is used to both initially store the biometrics of the user in memory and subsequently to authenticate the user against those stored biometrics. As in U.S. Pat. No. 4,582,985 the use of traditional biometric approaches requires a microprocessor on the chip, with its accompanying cost and power consumption. Reading the fingerprint sensor data and extracting biometric information from it requires a microprocessor that directs serial procedural processing steps. Because of the cost, size, and energy requirements of such an application there is still today no successful commercial application of on card fingerprint verification that will fit on an ISO-compliant financial card and/or ID card.

A recent patent, U.S. Pat. No. 6,681,034 to Russo attempts to address this ongoing issue of the large computational power needs of fingerprint verification by breaking up the totality of data from a fingerprint sensor and generating measured templates having a plurality of data chunks from data read by the fingerprint sensor and only working on one chunk at a time. In the final analysis though the solution of this patent still results in a significant microprocessor need and the microprocessor(s) are placed in the card reader rather than the card. The difficulty of executing conventional fingerprint biometric matching on a smart card is mainly due to the limited computational capabilities and memory on a conventional smart card. A conventional smart card typically has less than 512 bytes of RAM and between 1 and 16 kilobytes of memory. An 8-bit RISC (reduced instruction set computer) microprocessor has a speed between 1 and 10 Megahertz, which is quite slow considering the magnitude of computations required for biometric comparisons.

Traditional biometric approaches such as the above also have raised security issues in that there is potential for extracting conventional biometric information off of a card to obtain a user's fingerprint information. There is clearly a need for a verification approach that cannot be broken down to yield fingerprint information about the user.

What is needed then is a different approach. One that does not require any of the computationally intensive processes on the carrier but still verifies fingerprints to high accuracy. Also an approach is needed that guarantees that the fingerprint information cannot be extracted illegally from the carrier. The instant invention accomplishes that by a completely different approach than the prior art.

### SUMMARY

These and other needs are addressed by the present invention. For description purposes a fingerprint biometric example will be used. The carrier could be a financial transaction card, an ID card, or a keyless wireless entry device for example. As will be explained later some of these cards and devices do have limited microprocessor, memory, and battery power but usually not sufficient to handle the complex computational needs of conventional biometrics verifications. The achievement of making the actual biometric authentication process into a small, fast, low power, and accurate implementation is accomplished by doing the enrollment process off line one time in a controlled manner by using fingerprint information of the carrier user in combination with a representative database of other fingerprints to train a neural net. Upon completion of that training the only information transmitted to the carrier is the set of neural net weights. The carrier already has an embedded “neural net engine” corresponding to the one used in the enrollment process so the addition of the neural net weights corresponding to the user's fingerprints completes the information needed for verification. When the user activates the verification process by pressing the appropriate finger on a validation sensor the data from the validation sensor are transmitted directly to the neural net engine which processes the data to give a yes or no answer based on the previously developed neural net weights of the user's fingerprint information. The neural net engine is a straightforward circuit that emulates the neural net with a simple set of multiplications and additions and calculates a single output number that is indicative of a binary answer—whether there is a match or not. There is no complex algorithm to execute; therefore no significant microprocessor is even needed on the carrier. There is no fingerprint template stored on the card as with conventional biometrics. No information regarding the fingerprint of the user is on the card other than the neural net weights. Those weights are unreadable by external means and even if read could not be used to reconstruct the fingerprint so there is no privacy issue as with conventional biometrics. This invention requires less physical fingerprint sensor resolution than existing implementations of fingerprint authentication because the entire available fingerprint image is resolved to neural net weights which contain a great deal of data. Typical implementation of fingerprint authentication distills large amounts of data into discrete, arbitrary mathematical constructs called “biometrics”, and a great deal of information is discarded in that process.

One aspect of the instant inventions is then a system for personal identity verification that includes at least a computer based enrollment system for training a neural net to obtain neural net weights for a biometric of a user; a carrier, at least one biometric sensor mounted on the carrier, and neural net engine circuitry mounted on said carrier and having stored neural net weights obtained from the computer based enrollment system for the user.

Another aspect of the instant invention is a method for personal identity verification including at least the steps of; sensing enrollment information related to a biometric of a user that is recorded by an enrollment sensor, transferring that enrollment information to a computer, combining that enrollment information with samples from a representative database of biometrics from other individuals to form a training set, using the training set and a computer algorithm in the computer to train a pre-chosen neural net structure to preferentially select the biometric of the user and in so doing calculating a chosen set of neural net weights, transferring that chosen set of neural net weights into neural net circuitry attached to a carrier, sensing validation information relative to a biometric of a user that is recorded by a biometric validation sensor attached to the carrier, transferring that validation information to the neural net circuitry to generate a verification value at the output node, and producing an acceptance signal when the value generated by the output node is within a pre-determined acceptance range.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of the components and a flow chart of the present invention making a fingerprint lock for a single user.

FIG. 2 is a diagram of the components and a flow chart of the present invention making individual fingerprint locks for multiple users.

FIG. 3 is a diagram illustrating a possible neural net configuration for representing biometric data.

FIG. 4 is a diagram illustrating a second possible neural net configuration for representing biometric data.

### DETAILED DESCRIPTION

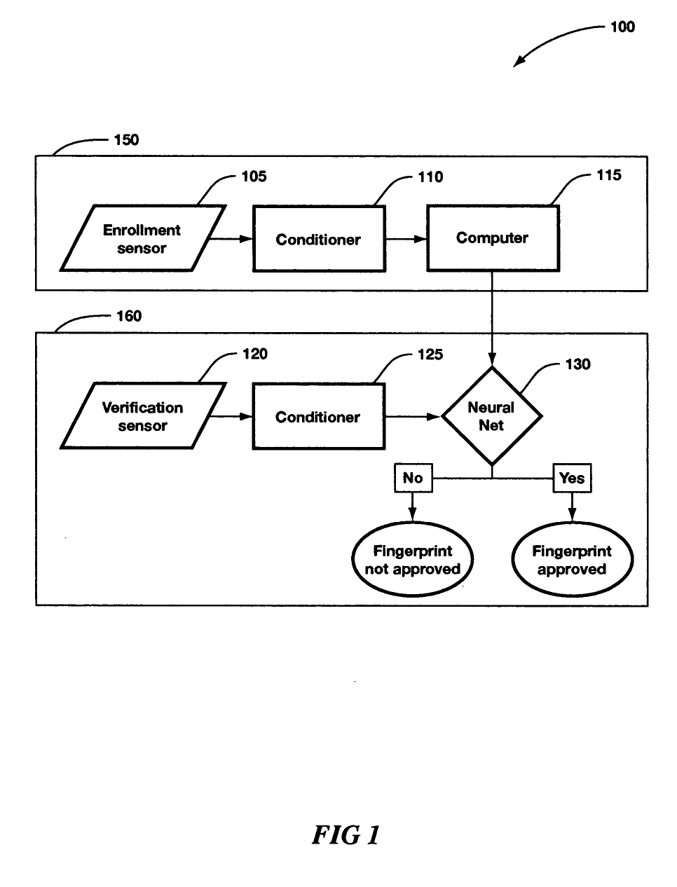

FIG. 1 is a representation of the overall process using the instant invention, represented generally by the numeral 100. Process block 105 represents a commercially available fingerprint sensor and is referred to as the enrollment sensor. When a fingerprint is pressed on enrollment sensor 105 a data stream from the enrollment sensor is sent to block 110, which digitizes the data stream and passes it to block 115. Block 115 is a computer, which could be setting next to the sensor in block 105 or be in a remote location. Computer 115 contains software especially designed for the training of neural nets. Also contained in computer 115 is a representative collection of fingerprint templates. Training of a neural net is performed by sampling 5 to 10 samples from the sensor and combining those with a sample set from the fingerprint templates to create a training set that is used to train the neural net. The net is trained so it generates a significantly different output from the sensed fingerprints from block 105 than the output it generates from the representative fingerprint database. When the training is complete the set of neural net weights become the data that will be eventually enrolled on the carrier of the invention.

Block 120, the validation sensor, is connected to a conditioner 125, which is connected to neural net circuitry 130 continuously, or one or more discrete times, these components carrying out the verification process. The neural net circuitry is connected continuously or one or more times to the programmable computer 115 through an enrollment interface.

It is important to note that module 160 comprising blocks 120,125, and 130 together represents a small, low power, low cost module that can be placed in a wide variety of applications to be described later. That module can have the neural net weights from enrollment computer 115 transferred into it before or after being embedded into a variety of the carriers to be described later.

Module 150 comprising blocks 105, 110, and 115 together represents an enrollment process or system. Module 150 could be located in close proximity to module 160 during the enrollment process or be in a remote location with communication via phone or Internet.

The enrollment sensor 105 and validation sensor 120 will depend on the biometric being measured. They could for example be fingerprint sensors, microphones for voice authentication, or cameras or digital scanners for iris or retina authentication. In the fingerprint case the sensors tend to be thin structures of touch sensitive material. These are often sensor matrices that create a digitized image of a fingerprint placed in contact with its surface. There are many such products on the market and can be area (matrix) sensors or a swipe sensors. This invention anticipates the use of any of them. In the preferred mode both enrollment sensor 105 and validation sensor 120 will be of identical design. A preferred sensor is the BLP-60 fingerprint sensor manufactured by BMF Corporation.

Computer 115 is a standard computing device consisting of a central processor with memory and a storage device containing algorithms to train a neural net and thereby compute neural net weights. The computer also can access a database of representative fingerprint templates. The storage devices contain pre-defined neural net structural design created by a neural net algorithm. The aforementioned algorithms and structures are those that can be designed and built by one skilled in the art of designing and using neural networks. The storage devices may also contain program instructions to execute back or forward propagation or custom designed neural net training algorithms to calculate weights. The weights, and data describing the nodes to which they are assigned, are carried to the neural net circuitry 130 via a direct wire or fiber-optic cable or indirectly through a network, like the Internet, or a local area network.

Computer 115 could for example be a desktop computer at a bank used to enroll card users but it could also be a central server that receives data from enrollment sensor 105 via phone lines or Internet connection. Another approach could be for intermediate transfer devices such as for example a laptop computer that could download neural net weights from multiple enrollment sessions and then be moved around to field install the neural net weights into field modules of module 160 of FIG. 1. The instant invention anticipates any of these possibilities. The neural net circuitry 130 is a chip device containing the same neural net structure as the one used in generating the neural net weights from computer 115 for one or more fingerprints. Conditioners are simple computational processing units with instruction sets for digitizing data signals. There are many of these types of conditioners on the market and the invention anticipates the use of any of them.

For the initial transfer of the neural nets weights from computer 115 to neural net engine circuitry 130 on the carrier a transfer device (not shown) would be used to transfer the neural net weight data from computer 115 to neural net engine circuitry 130. A number of commercial products are available to transfer information into carriers such as financial transaction cards and the invention anticipates the use of any of them. Likewise if the carrier were a keyless wireless entry device a transfer device that would easily connect computer 115 to the keyless wireless entry devices would be a straightforward design matter for a person skilled in the art.

The neural net circuitry 130 receives the weights and node assignments and stores them in a circuit structure matching the network structure in computer 1 15 at their assigned nodes. When the above step is completed, the neural net circuitry is ready to be used. A person places their finger on the validation sensor attached to the neural net circuitry. The validation sensor then outputs a stream of modulated data carrying information about the fingerprint characteristics. This data is modulated further by the conditioner and passes the result to the neural net circuitry via a direct wire or fiber-optic cable or indirectly through a network, like the Internet, or a local area network. The neural net circuitry processes the data through its neural network circuit design with the calculations performed by its computational processing unit. The neural net circuitry outputs a value indicating whether or not the fingerprint placed on validation sensor 120 is a close match to the fingerprint originally pressed on enrollment sensor 105.

It is important to understand that in use the verification step of the neural net does not involve analyzing a fingerprint template obtained from validation sensor120. No biometric templates are prepared or stored as in much of the prior art. The data from validation sensor120 is transmitted to the neural net structure of neural net circuitry 130, which generates a yes or no answer using the neural net weights previously downloaded from programmable computer 115. The logic algorithm built into neural net circuitry 130 is a set of multiplications and additions with no conditional branching and little intermediate memory storage. This aspect of the instant invention enables the use of a low cost, small size, low energy consumption circuit that can fit within the specifications of current ISO compliant financial and transaction and ID card designs. These benefits of the neural net circuitry would apply to other biometrics such as those obtained from microphones or cameras and thus could be voice, iris, retina, face, or hand print data and would apply if the carrier were a smart card or a keyless wireless entry device for example.

A particular strength of the instant invention is that the computationally intense step in biometric authentication has now been moved completely to the enrollment process, and the enrollment process is normally only done once or at most a few times. The actual verification step, which will ordinarily be done many times, has been converted into a parallel processing computation that can be carried out in hard wired circuitry without a complex microprocessor required. In this way the initially stated goal of finding a small, low cost, low power required portable verification solution is achieved.

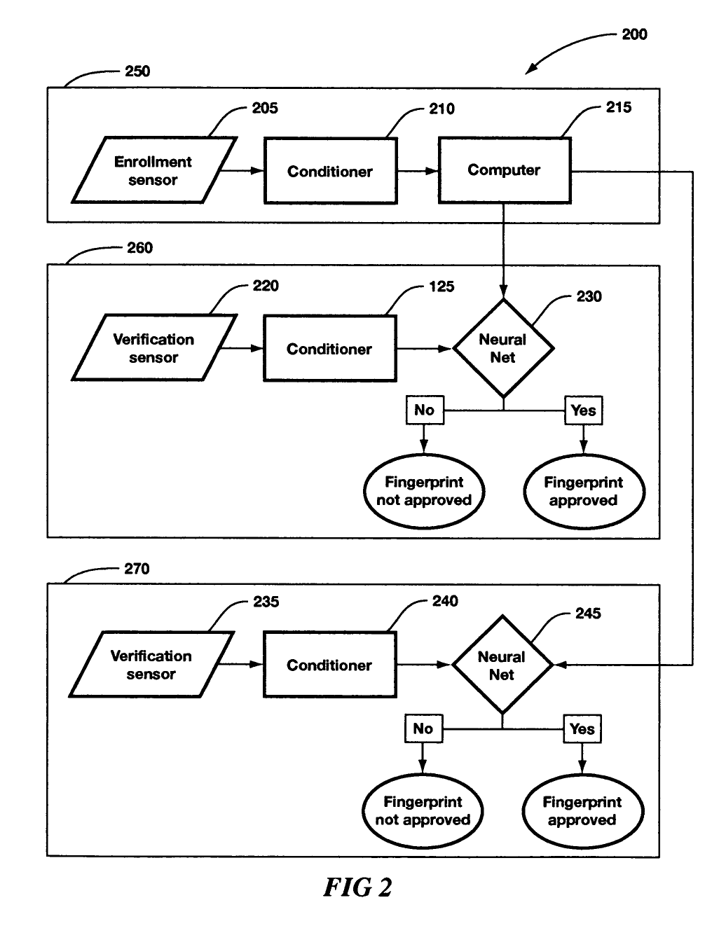

The low cost, small size, low energy consumption aspect of the neural net circuitry makes it possible to increase security by applying more than one biometric verification to the same carrier. FIG. 2 shows such a case, shown generally by the numeral 200. Blocks 205, 210, and 215 again make up an enrollment system as described before in FIG. 1. In this case the enrollment process sequence would be used two or more times to create neural net weights for two fingerprints. The first set of neural net weights would be enrolled onto neural net 230 and the second set of neural net weights would be enrolled onto neural net 245. In use the user would press one finger onto validation sensor 220 and a second finger onto validation sensor 235. As described previously each of the data flows from validation sensor 220 and validation sensor 235 would be applied directly to the neural nets of 230 and 245 respectively to generate verification signals. This arrangement could be two fingerprints from the same person or in special security situations it could be fingerprints from two different individuals that might be required.

The neural net circuitry is a chip type data storage device of optional size containing an integrated circuit with a neural net structure and associated weights, with data storage and random access memory used by the chip. There are many different kinds of this physical device on the market and under development. This invention anticipates the use of any of them.

The conditioners are small computational processing units with instruction sets to modify the data coming from a sensor to evenly modulate it or remove extraneous noise. There are many structural variations in the marketplace for conditioners of this type, which are sometimes also known as post-processors or pre-processors of data. These may take the form of microprocessors on an integrated circuit or a central processing unit in a computer. This invention is envisioned to be able to use any of them.

One application mentioned several times earlier is the use of the instant invention in a “smart card”. As further background the term smart card is often used to describe any kind of card with a capability to relate information to a particular application such as a magnetic stripe, optical, memory, and microprocessor cards. It is more precise however to refer to memory and microprocessor cards as smart cards. A magnetic stripe card has a strip of magnetic tape attached to its surface. This is the standard technology used for bankcards. Optical cards are bankcard size plastic cards that use some sort of laser to write and read the card. Memory cards can store a variety of data, including financial, personal, and specialized information; but cannot ordinarily process information. Smart cards with a microprocessor look like standard plastic cards, but are equipped with and embedded integrated circuit chip. These can store information, carry out local processing on the data stored, and perform rudimentary software code. These cards take the form of either “contact” cards that can communicate via pin contacts with a card reader/writer or “contact-less” cards which use radio frequency signals to communicate with the outside world.

Reference is also made to ISO compliant financial transaction cards or ID cards. ISO 7816 is an international smart card protocol that spells out standards for card sizes, pin connections, electrical requirements, etc. to ensure that these cards and the devices interacting with them can used around the world and that third party sources can design there applications to them. There are other ISO standards that cover for example RFID cards, which are contact-less cards using radio frequency transmitters to communicate over short distances.

Smart card readers, also known as smart card programmers, card terminals, card acceptance devices, or interface devices are used to read data from and write date to a smart card. These readers can be integrated into standard computers and today some computers already come equipped with smart card readers. The instant invention anticipates the use of any of these devices in communicating between the enrollment computer depicted in FIG. 1 and FIG. 2 and the neural net circuitry on the carrier. In addition that communication could be done by wireless radio frequency (RF) signals.

An artificial neural network (ANS) is a computer-based architecture, which emulates the human neural system in the brain. It consists of nodes and weighted links that connect the nodes. A completed ANS can contain hundreds of nodes and thousands of links. Each node is a nonlinear transformation. The structure of the net contains input nodes that receive the data from outside of the net. This is akin to the data received in the brain from human sensors, e.g. eyes. The nodes send signals out to succeeding nodes. The nodes that provide the outputs to the user are the output nodes. In between the input and output there can be other nodes that are called hidden nodes. There can be one or more layers of such hidden nodes. The hidden nodes can accept inputs from multiple other nodes. The output nodes identify the nature of the output, e.g. eyes looking at a painting provide an input to the brain, and then the brain concludes or outputs that the received data is from a painting. An ANS can be thought of as multi-dimensional input/output pattern mapping. The signal, or input pattern, from the outside is input into the ANS through the input nodes. Those signals will propagate to the hidden nodes, and finally to the output nodes through the links. The signals will be manipulated by the weight associated with each link and the nonlinear transformation in each node. The output represents the ANS ‘conclusion.’ ANS has shown to be very successful in many areas such as: pattern recognition, signal processing, non-linear modeling, etc.

The key to constructing an ANS to perform a desired function is to find how many nodes need to be connected together, how many hidden layers should be used and how the connecting links are weighted. There is no method to simply assign those unknowns directly. The approach used by scientists and engineers is called “training” or “learning by trial and error”, just as a human does. There are many commonly used training algorithms. The instant invention anticipates the use of a variety of neural net structures and a number of training methods.

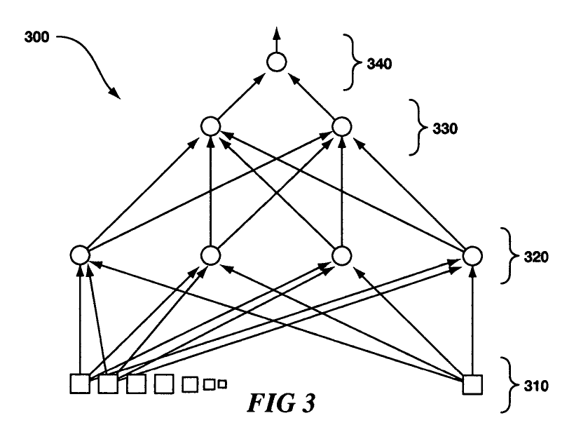

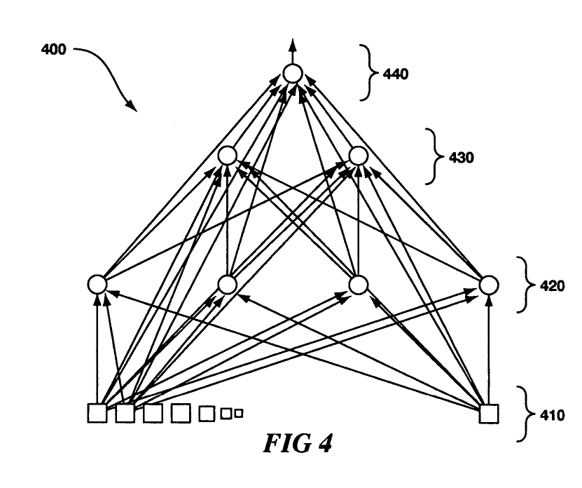

In any given neural net structure the number of connections can also vary depending on whether each layer is only connected to its next layer or is connected also to further removed layers. For example in a four layer net the nodes in layer 2 are often connected to the layers in layer 3 but it is possible to increase the complexity of the net by also connecting the nodes in layer 2 to the nodes in layer 4. FIG. 3-4 illustrates this by showing two neural net structures that are identical with respect to the number of nodes but the first (FIG. 3) has only inter-layer connections. In FIG. 3 the neural net is represented generally by the numeral 300. Input layer 310 has 1024 nodes with only a few shown for clarity. The first hidden layer 320 of four nodes is connected to each of the 1024 nodes of input layer 310 and forward connected to the second hidden layer 330. The second hidden layer 330 of 2 nodes is connected to the nodes of hidden layer 320 as well as to output layer 340. The second neural net (FIG. 4) represented generally by the numeral 400 has an identical node structure but has both inter and intra layer connections. For example each node in input layer 410 is connected not only to the nodes in hidden layer 420 but also to the nodes in hidden layer 430 and the single node in output layer 440. The increased interaction between nodes is evident. For purposes of this description and to concisely describe the invention a neural net of the type of FIG. 3 is defined as an inter-layer connected net. A neural net of the type of FIG. 4 is defined as an inter and intra-layer connected net.

Although as mentioned before any number of neural net structures with a differing number of nodes and a differing number of hidden layers could be effectively used for purposes of this invention a preferred embodiment effective for biometric validation is a custom neural net chip with 2 hidden layers, less than 17 neurons, and both inter and intra layer connections.

There has thus been outlined, rather broadly, the more important features of the invention in order that the detailed description thereof may be better understood, and in order that the present contribution to the art may be better appreciated. Although most of the description was given for examples similar to smart cards it was noted earlier that module 160 comprising blocks 120, 125, and 130 in FIG. 1 represents a small, low power, low cost module that can be placed in a wide variety of applications. Some potential examples will now be given.

For example the carrier of the instant invention could be a doorframe on a home or building or a pilots cabin with module 160 of FIG. 1 embedded. Only authorized persons would be able to unlock the door. A motor vehicle's door or dashboard could be a carrier and only authorized persons could enter or drive the vehicle after verification with any of several biometrics. Identification cards for individuals based on module 160 of FIG. 1 could be produced which would provide a visual display in response to a recorded fingerprint of the proper user.

For example the carrier could also be a financial transaction card. The card reader and the network used to process this card are exactly the same as is currently used. In this example, the card is always in an “invalid” state. No contact with a central processing network would be needed to decline the card, as the card reader would not register it as a valid card at the moment of swipe. No unauthorized user could activate the card, since he would possess the wrong fingerprint. However when the enrolled user puts their fingerprint on the card the neural net registers a “match” and activates the magnetic stripe for a pre-determined elapsed time. The card reader detects the data from the swipe as being from a valid credit card, contacts the central processing network which approves or denies the transaction. The card reader and network connection is the same as devices currently deployed in the marketplace so no infrastructure changes are needed.

For example a military application could be intelligent dog tags issued to members of a division. The dog tags would have a module 160 (FIG. 1) and would validate the card for a pre-determined elapsed time when the neural net detected a matching fingerprint. The intelligent dog tag would contain highly encrypted data respecting the person to whom it was issued, such as his unit, security level, rank, and serial number, perhaps even a photo image could be embedded in the data. Upon entering or leaving a secure area the authorized person swipes the card in a fixed card reader at a guard station after first imprinting his fingerprint upon its validation sensor. The same could be done with a different biometric such as voice. In this particular example no contact with a central network would be required prior to authorization.

For example the carrier could be a police handgun with module 160 of FIG. 1 attached. The handgun is in a constant state of “safety on”, that is, it cannot be fired because a bar is blocking the firing pin mechanism. When the officer assigned to carry this weapon places their fingerprint on the weapon, a match will be registered, and a battery-operated solenoid withdraws the bar disabling the firing pin. The weapon is now “safety off” and ready to fire.

For example the carrier could be a keyless wireless entry device similar to those used to lock and unlock automobile doors. The module 160 of FIG. 1 could be embedded into the design of the device so that only the neural net weights of the user need be added by a contact device from enrollment computer 115 or via a wireless transmission. The biometric might be fingerprint, voice, or others. The keyless wireless entry could then have frequencies programmed into it to open the users motor vehicles and/or building doors.

For example the carrier could be a cellular telephone in which neural net circuitry 130 of FIG. 1 is incorporated into the cellular phone chip. In this application the phone microphone represents validation sensor 120. Enrollment could be done by a telephone call to computer 115 in which a password phrase would be spoken a few times. The phrases would be fed to the neural net training software of computer 115 to train the neural net and obtain neural net weights. These weights would then be returned to the cellular phone by a second phone call and the weights would be transferred into the memory of the cellular phone. The neural net weights would then be applied to the embedded neural net circuitry 130 and used each time the user uses the cellular phone. The user would speak the password phrase, which would be fed to the neural net circuitry with its already ported neural net weights to either validate or invalidate that the correct user has the cellular phone.

For example the carrier could be a computer in which neural net circuitry 130 of FIG. 1 is incorporated into the computer board. Fingerprint sensor 120 could be in the computer via a PC card or via an external sensor attached by a USB port for example. Enrollment via enrollment computer 115 could be done over phone lines through a modem or via the Internet. Neural net weights could be downloaded from enrollment computer 115 via pone lines through a modem or via the Internet. Upon start-up of the computer the computer start-up sequence could request the user to press the appropriate fingerprint onto the fingerprint sensor, which would then apply the fingerprint sensor data to neural net circuitry 130 to obtain a validation. Again, such an application would not be limited to the fingerprint as the biometric. The validation could replace passwords or be used in combination with passwords for stronger security.

It should be evident that some combinations of the above ideas could be incorporated into other digital devices such as personal digital assistants (PDA's) or digital cameras that have onboard processors and memory.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for personal identity verification comprising:
a computer based enrollment system for training a neural net to obtain neural net weights for a biometric of a user;
a carrier;
a validation biometric sensor for capturing a biometric reading from said user, mounted on said carrier and connected to said neural net engine circuitry; and
neural net engine circuitry mounted on said carrier and having memory for stored neural net weights obtained from said computer based enrollment system for said user.

2. The system for personal identity verification of claim 1 wherein said validation biometric sensor upon activation transmits data to said neural net engine circuitry and said neural net engine circuitry generates an acceptance signal when the value generated by an output node of said neural net engine circuitry is within a predetermined acceptance range.

3. The system for personal identity verification of claim 2 wherein said acceptance signal activates a visual display.

4. The system for personal identity verification of claim 2 wherein said acceptance signal activates an audio speaker.

5. The system for personal identity verification of claim 2 wherein said acceptance signal activates a magnetic stripe.

6. The system for personal identity verification of claim 5 further comprising deactivating said magnetic stripe after a pre-determined elapsed time.

7. The system for personal identity verification of claim 2 wherein said acceptance signal activates an electrical switch.

8. The system for personal identity verification of claim 2 wherein said acceptance signal activates a wireless transmitter.

9. The system for personal identity verification of claim 1 wherein said carrier is a financial transaction card.

10. The system for personal identity verification of claim 1 wherein said carrier is an identification card.

11. The system for personal identity verification of claim 1 wherein said carrier is attached to a motor vehicle.

12. The system for personal identity verification of claim 1 wherein said carrier is attached to a building entrance.

13. The system for personal identity verification of claim 1 wherein said carrier is a keyless wireless entry device.

14. The system for personal identity verification of claim 1 wherein said carrier is a cellular telephone.

15. The system for personal identity verification of claim 1 wherein said carrier is a computer.

16. The system for personal identity verification of claim 1 wherein said computer based enrollment system comprises:
an enrollment biometric sensor for capturing a biometric reading from said user;
a computer connected to said enrollment biometric sensor; and
neural net training software in said computer.

17. The system for personal identity verification of claim 16 wherein said validation biometric sensor and said enrollment biometric sensor are fingerprint sensors.

18. The system for personal identity verification of claim 16 wherein said validation biometric sensor and said enrollment biometric sensor are microphones.

19. The system for personal identity verification of claim 16 wherein said validation biometric sensor and said enrollment biometric sensor are cameras.

20. The system for personal identity verification of claim 16 wherein said validation biometric sensor and said enrollment biometric sensor are digital scanners.

21. The system for personal identity verification of claim 1 wherein said neural net engine neural net engine circuitry mounted on said carrier has both inter and intra layer connections of all nodes.

22. The system for personal identity verification of claim 1 wherein:
said carrier is a financial transaction card;
said validation biometric sensor for capturing a biometric reading from said user is a fingerprint sensor; and
said neural net engine circuitry mounted on said carrier has both inter and intra layer connections of all nodes.

23. The system for personal identity verification of claim 1 wherein:
said carrier is an identification card;
said validation biometric sensor for capturing a biometric reading from said user is a fingerprint sensor; and
said neural net engine circuitry mounted on said carrier has both inter and intra layer connections of all nodes.

24. A method for personal identity verification comprising the steps of:
sensing enrollment information related to a biometric of a user that is recorded by an enrollment sensor;
transferring said enrollment information to a computer;
combining said enrollment information with samples from a representative database of biometrics from other individuals to form a training set;
using said training set and a computer algorithm in said computer to train a pre-chosen neural net structure to preferentially select said biometric of a user and in so doing calculating a chosen set of neural net weights;
transferring said chosen set of neural net weights into neural net circuitry attached to a carrier;
sensing validation information relative to a biometric of a user that is recorded by a biometric validation sensor attached to said carrier;
transferring said validation information to said neural net circuitry to generate a verification value at the output node; and
producing an acceptance signal when the value generated by said output node is within a pre-determined acceptance range.

25. The method of personal identity verification of claim 24 wherein said produced acceptance signal activates a visual display.

26. The method of personal identity verification of claim 24 wherein said produced acceptance signal activates an audio speaker.

27. The method of personal identity verification of claim 24 wherein said produced acceptance signal activates a magnetic stripe.

28. The method of personal identity verification of claim 27 further comprising deactivating said magnetic stripe after a pre-determined elapsed time.

29. The method of personal identity verification of claim 24 wherein said acceptance signal activates an electrical switch.

30. The method of personal identity verification of claim 24 wherein said acceptance signal activates a wireless transmitter.

31. The method of personal identity verification of claim 24 wherein said carrier is a financial transaction card.

32. The method of personal identity verification of claim 24 wherein said carrier is an identification card.

33. The method of personal identity verification of claim 24 wherein said carrier is a keyless wireless entry device.

34. The method of personal identity verification of claim 24 wherein said carrier is attached to a motor vehicle.

35. The method of personal identity verification of claim 24 wherein said carrier is attached to a building entrance.

36. The method of personal identity verification of claim 24 wherein said carrier is a cellular phone.

37. The method of personal identity verification of claim 24 wherein said carrier is a computer.

38. The method of personal identity verification of claim 24 wherein said validation biometric sensor and said enrollment biometric sensor are fingerprint sensors.

39. The method of personal identity verification of claim 24 wherein said validation biometric sensor and said enrollment biometric sensor are microphones.

40. The method of personal identity verification of claim 24 wherein said validation biometric sensor and said enrollment biometric sensor are cameras.

41. The method of personal identity verification of claim 24 wherein said validation biometric sensor and said enrollment biometric sensor are digital scanners.

42. The method of personal identity verification of claim 24 wherein said neural net engine neural net engine circuitry mounted on said carrier has both inter and intra layer connections of all nodes.

43. The method of personal identity verification of claim 24 wherein:
said carrier is a financial transaction card;
said validation biometric sensor for capturing a biometric reading from said user is a fingerprint sensor; and
said neural net engine circuitry attached to said carrier has both inter and intra layer connections of all nodes.

44. The method of personal identity verification of claim 24 wherein:
said carrier is an identification card;
said validation biometric sensor for capturing a biometric reading from said user is a fingerprint sensor; and
said neural net engine circuitry attached to said carrier has both inter and intra layer connections of all nodes.
